(19) United States
(12) Patent Application Publication
(10) Pub. No.: US 2023/0196368 A1
(43) Pub. Date: Jun. 22, 2023

(54) SYSTEM AND METHOD FOR PROVIDING CONTEXT-BASED FRAUD DETECTION

(71) Applicant: Source Ltd., Valletta (MT)

(72) Inventors: Shmuel UR, Shorashim (IL); Guy ROTH, Rehovot (IL)

(73) Assignee: Source Ltd., Valletta (MT)

(21) Appl. No.: 17/554,277

(22) Filed: Dec. 17, 2021

(51) Int. Cl. G06Q 20/40; G10L 15/22; G10L 25/63

(52) U.S. Cl. CPC G06Q 20/4016; G10L 15/22; G10L 25/63

(57) ABSTRACT

Systems and methods of providing context-based fraud detection receive a transaction request from a user, the transaction request comprising request parameters; implement a fraud analysis on the transaction request based on the transaction request and/or the request parameters; determine an initial likelihood of fraud based on the fraud analysis; if the initial likelihood of fraud meets a likelihood threshold: identify a suspected fraud type based on at least one of the transaction request, the request parameters, or the fraud analysis; select questions associated with the suspected fraud type to be presented to the user; receive a voice input from the user in response to the presented questions; implement a second fraud analysis on the voice input based on at least one of the transaction request, the request parameters, or the fraud analysis; and determine a revised likelihood of fraud based on the second fraud analysis.

### FIELD OF THE INVENTION

The present invention relates to fraud detection. More particularly, the present invention relates to systems and methods for providing context-based fraud detection.

### BACKGROUND OF THE INVENTION

There are many different common types of fraud, such as credit card fraud and identity fraud. To combat fraud, enterprises such as merchants and banks typically employ a variety of fraud detection systems. There are many types of fraud performed using voice, e.g., either over a phone line or in person, e.g., in a shop. A fraudster who is aware he or she is committing fraud and intends to deceive the merchant (or the credit card company) may exhibit stress, which can, in certain circumstances, be detected in the fraudster's voice, e.g., using a fraud detection system that analyzes voices and detects stress.

However, these fraud detection systems are susceptible to circumvention due to inefficiencies and limitations in these systems. For example, typical fraud detection systems rely on stress related to lying as a means for identifying fraud. Lie detection relies on making the speaker worry and thus exhibit detectable signs of stress. However, stress is not synonymous with lying, nor is it a trait that is guaranteed to be exhibited by one who is lying. For example, if a fraudster has no compunction about committing the fraud or no fear of getting caught lying, there may be no stress in the fraudster's voice despite the utterance of a lie, and therefore no stress detected. Additionally, fraudsters may not be required to lie in order to commit a fraud. For example, if a fraudster lies regarding what they plan to do with an issued credit card, but does not lie about their identity, then a question asking for the fraudster's mother's maiden name (a common security question for identification purposes) will not introduce stress as the answer is truthful (despite the malicious intent of the fraudster with respect to the card's future use).

### SUMMARY OF THE INVENTION

Embodiments of the present invention include methods for providing context-based fraud detection. Embodiments may receive, by a processor, a transaction request from a user, the transaction request including request parameters, and implement a first fraud analysis on the transaction request based on at least one of the transaction request or the one or more request parameters. An initial likelihood of fraud may be determined based on the first fraud analysis, and if the initial likelihood of fraud meets a first likelihood threshold: a process may identify a suspected fraud type based on at least one of the transaction request, at least one of the one or more request parameters, or the first fraud analysis. A process may select questions associated with the suspected fraud type to be presented to the user and receive a first voice input from the user in response to the one or more presented questions. A second fraud analysis on the first voice input may be implemented based on at least one of the transaction request, the one or more request parameters, or the first fraud analysis. A revised likelihood of fraud may be determined based on the second fraud analysis.

In accordance with further embodiments of the invention, systems may be provided which may implement the methods described herein according to some embodiments of the invention.

These and other aspects, features and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a high level diagram illustrating an example configuration of a system for providing context-based fraud detection, according to at least one embodiment of the invention; and

FIG. 2 is a flow diagram of a method for providing context-based fraud detection, according to at least one embodiment of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the detailed description herein, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Two categories of fraud which are commonly perpetrated by fraudsters are identity fraud and owner fraud. Identity fraud is the use by one person of another person's personal information, without authorization, to commit a crime or to deceive or defraud that other person or a third person. Non-limiting examples of identity fraud include attempting to charge a credit card without the card being present while claiming to be the owner, applying for new card in someone else's name, taking over an account of another person (e.g., using social engineering), etc. Owners fraud is fraud committed by someone who may legitimately have access to an account (i.e., there is no identity fraud) but who misappropriates that legitimate access in order to commit fraud. Non-limiting examples of owners fraud include:

Intentional friendly fraud, for example, when a consumer makes a purchase and recognizes the purchase, but still requests a credit from the issuing bank, claiming they did not make the purchase.

Shared card fraud, for example, when multiple consumers share a card (e.g., a card shared with family members), if one person uses the card and does not inform the other, this can lead to friendly fraud.

Policy abuse fraud, for example, a policy which allows users to return items within a certain time limit without needing to provide a reason. Such policies do not typically limit the number of times a purchaser can return items or request a refund. However, many companies take action if they feel a shopper is abusing the policy.

Stress and emotion may be expected reactions of those perpetrating fraud; however, the stress level depends on what the person is doing. For example, with identity fraud, the user may exhibit stress regarding a question related to identity but not regarding a question related to a company return policy. With friendly fraud, the user may be stresses regarding questions related to his plan with the product but exhibit no stress or emotion regarding his identity (e.g., questions about personal information). In shared card fraud, the person may be stressed regarding his permission to use the card but not regarding the purchase itself. In order to properly detect these and other types of fraud, embodiments of the invention provide context-based fraud detection, specifically forced or guided context to detect fraud in a speaker's voice.

In various embodiments, different kind of tools may be implemented to detect different fraud types, and in some embodiments a single tool can differentiate the possible fraud types, e.g., using statistical understanding of transactions as well as voice analysis to detect stress if voice was used. As described herein, embodiments of the invention may initially use standard tools and/or strategies to identify likely fraud. Then, embodiments of the invention add relevant questions to the user dialog to guide the conversation and figure out if the stress is generic or question specific, which may lead to higher success rates in fraud detection, as described herein.

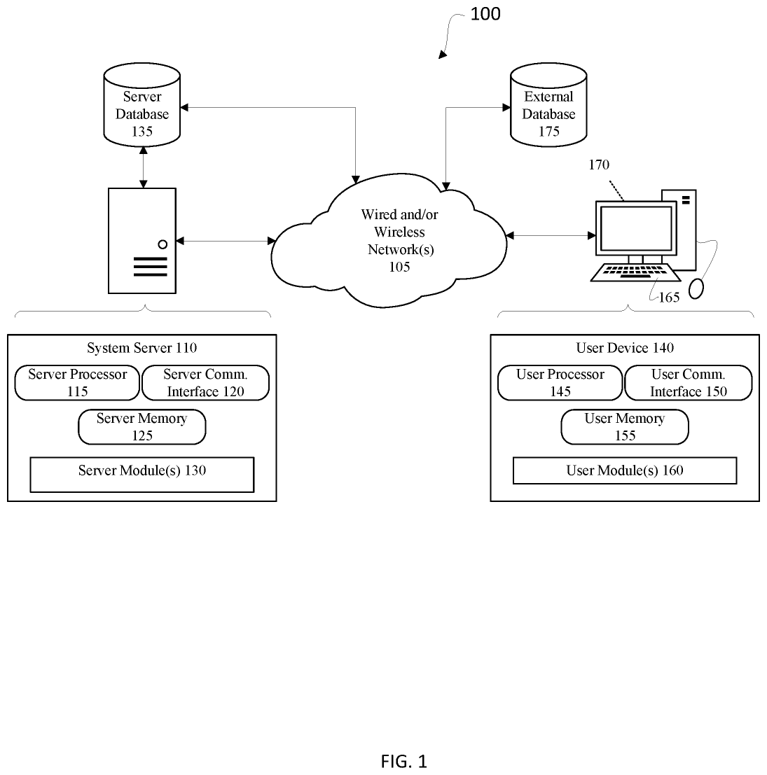

FIG. 1 shows a high1level diagram illustrating an example configuration of a system 100 for performing one or more aspects of the invention described herein, according to at least one embodiment of the invention. System 100 includes network 105, which may include the Internet, one or more telephony networks, one or more network segments including local area networks (LAN) and wide area networks (WAN), one or more wireless networks, or a combination thereof. System 100 also includes a system server 110 constructed in accordance with one or more embodiments of the invention. In some embodiments, system server 110 may be a stand-alone computer system. In other embodiments, system server 110 may include a network of operatively connected computing devices, which communicate over network 105. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 105.

System server 110 may be any suitable computing device and/or data processing apparatus capable of communicating with computing devices, other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, mainframes, and other appropriate computers and/or networked or cloud based computing systems capable of employing the systems and methods described herein.

System server 110 may include a server processor 115 which is operatively connected to various hardware and software components that serve to enable operation of the system 100. Server processor 115 serves to execute instructions to perform various operations relating to advanced search, and other functions of embodiments of the invention as described in greater detail herein. Server processor 115 may be one or a number of processors, a central processing unit (CPU), a graphics processing unit (GPU), a multi-processor core, or any other type of processor, depending on the particular implementation.

System server 110 may be configured to communicate via communication interface 120 with various other devices connected to network 105. For example, communication interface 120 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 110 to other computing devices and/or communication networks such as private networks and the Internet.

In certain implementations, a server memory 125 is accessible by server processor 115, thereby enabling server processor 115 to receive and execute instructions such a code, stored in the memory and/or storage in the form of one or more software modules 130, each module representing one or more code sets. The software modules 130 may include one or more software programs or applications (collectively referred to as the “server application”) having computer program code or a set of instructions executed partially or entirely in server processor 115 for carrying out operations for aspects of the systems and methods disclosed herein and may be written in any combination of one or more programming languages. Server processor 115 may be configured to carry out embodiments of the present invention by, for example, executing code or software, and may execute the functionality of the modules as described herein.

FIG. 1, the exemplary software modules may include a communication module, and other modules as described here. The communication module may be executed by server processor 115 to facilitate communication between system server 110 and the various software and hardware components of system 100, such as, for example, server database 135, client device 140, and/or external database 175 as described herein.

Of course, in some embodiments, server modules 130 may include more or less actual modules which may be executed to enable these and other functionalities of the invention. The modules described herein are therefore intended to be representative of the various functionalities of system server 110 in accordance with some embodiments of the invention. It should be noted that in accordance with various embodiments of the invention, server modules 130 may be executed entirely on system server 110 as a stand-alone software package, partly on system server 110 and partly on user device 140, or entirely on user device 140.

Server memory 125 may be, for example, a random access memory (RAM) or any other suitable volatile or non-volatile computer readable storage medium. Server memory 125 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 135, for example, directly or remotely via network 105. Database 135 may include any of the memory configurations as described herein, and may be in direct or indirect communication with system server 110. In some embodiments, database 135 may store information relating to user documents. In some embodiments, database 135 may store information related to one or more aspects of the invention.

As described herein, among the computing devices on or connected to the network 105 may be one or more user devices 140. User device 10 may be any standard computing device. As understood herein, in accordance with one or more embodiments, a computing device may be a stationary computing device, such as a desktop computer, kiosk and/or other machine, each of which generally has one or more processors, such as user processor 145, configured to execute code to implement a variety of functions, a computer-readable memory, such as user memory 155, a user communication interface 150, for connecting to the network 105, one or more user modules, such as user module 160, one or more input devices, such as input devices 165, and one or more output devices, such as output devices 170. Typical input devices, such as, for example, input devices 165, may include a keyboard, pointing device (e.g., mouse or digitized stylus), a web-camera, and/or a touch-sensitive display, etc. Typical output devices, such as, for example output device 170 may include one or more of a monitor, display, speaker, printer, etc.

In some embodiments, user module 160 may be executed by user processor 145 to provide the various functionalities of user device 140. In particular, in some embodiments, user module 160 may provide a user interface with which a user of user device 140 may interact, to, among other things, communicate with system server 110

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, user device 140 may be a “dummy” terminal, by which processing and computing may be performed on system server 110, and information may then be provided to user device 140 via server communication interface 120 for display and/or basic data manipulation. In some embodiments, modules depicted as existing on and/or executing on one device may additionally or alternatively exist on and/or execute on another device. For example, in some embodiments, one or more modules of server module 130, which is depicted in FIG. 1 as existing and executing on system server 110, may additionally or alternatively exist and/or execute on user device 140. Likewise, in some embodiments, one or more modules of user module 160, which is depicted in FIG. 1 as existing and executing on user device 140, may additionally or alternatively exist and/or execute on system server 110.

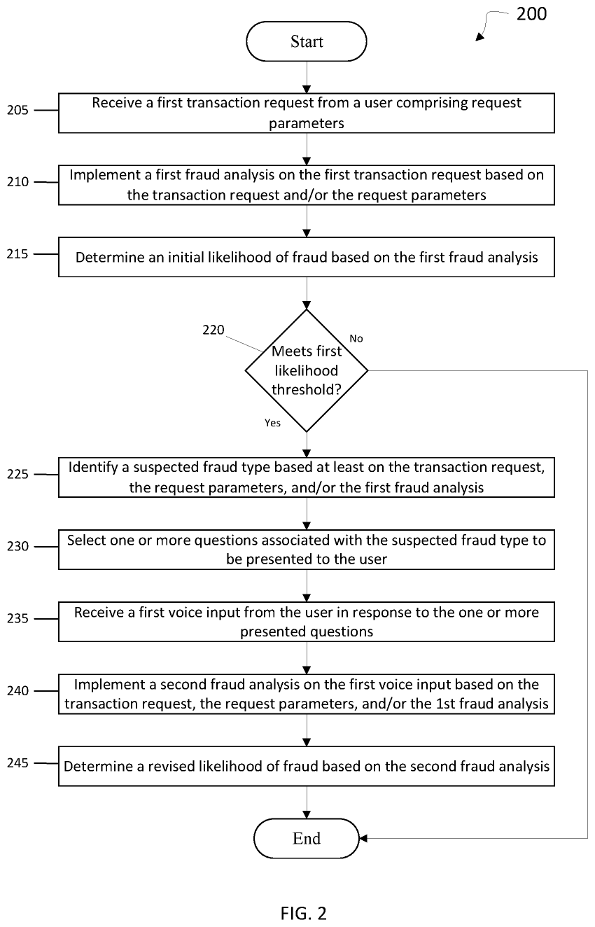

FIG. 2 is a flow diagram of a method 200 for providing context-based fraud detection, according to at least one embodiment of the invention. It should be noted that, in some embodiments, method 200 may be configured to implement one or more of the elements, features, and/or functions of system 100, e.g., as described in detail herein.

In some embodiments, method 200 may be performed on a computer having a processor, a memory, and one or more code sets stored in the memory and executed by the processor. In some embodiments, method 200 begins at step 205 when the processor may be configured to receive a first transaction request from a user, the first transaction request. In some embodiments, the first transaction request may include one or more request parameters. For example, in the context of a sale executed over the phone, a person may call a merchant to purchase, e.g., a computer or other product. Of course, transactions may take place in the real world (as opposed to virtually), e.g., when a customer enters a retail store or other physical establishment. During the transaction, the user (e.g., purchaser) may provide one or more request parameters, e.g., information about the user, information about the product to be purchased, transaction parameters, etc. Additional information such as the time of day, the location of the transaction, etc., may also be known. Of course, as explained herein, embodiments of the invention may be used for detecting fraud in non-monetary transactions or interactions as well, e.g., during an interview, etc. Accordingly, in some embodiments the initial transaction may be the providing of intimal information, e.g., in the form of an application or other documentation, etc.

Next, at step 210, in some embodiments, the processor may implement a first fraud analysis on the first transaction request, e.g., based on the first transaction request and/or the one or more request parameters. For example, in some embodiments, a first fraud analysis may be triggered based on the one or more request parameters (or a portion thereof), e.g., the fraud detection may be based on any information known to the fraud detection system. In some embodiments, machine learning (ML) algorithms may be implemented which may evaluate the available information regarding the request and/or parameters of the request, e.g., time, place, buyer, card history, purchase history, seller, electronic trails, etc., to detect fraud. In some embodiments, e.g., in instances where an initial voice input has been received, an initial (first) voice analysis of the initial voice input may also or alternatively be performed, to detect fraud in the caller's voice.

Next, at step 215, in some embodiments, the processor may be configured to determine an initial likelihood or probability of fraud based on the first fraud analysis. For example, in some embodiments, a first likelihood threshold may be set which enables calibration of the fraud detection system such that only suspected fraud that reaches a certain initial threshold level is treated with a higher level of caution and instances of lower-level suspicion (or no suspicion) are presumed to have no fraud. Accordingly, at step 220, if the initial likelihood of fraud does not meet a first likelihood threshold, then the fraud analysis may end. However, if the initial likelihood of fraud is above or otherwise meets a first likelihood threshold, then, at step 225, in some embodiments, the processor may identify a suspected fraud category or type, e.g., based on the first transaction request, the one or more request parameters, the initial voice analysis (when applicable), and/or the first fraud analysis, e.g., depending on which information was used in step 210.

For example, address information provided may not accurately correspond to previously provided address information associated with the phone number from which the call was initiated. Such a discrepancy may trigger an initial suspicion of identity fraud (e.g., a first likelihood threshold is met), requiring further analysis.

As another example, a product that was previously returned but is now being purchased again may attract the attention of the fraud detection system and may trigger an initial suspicion of policy fraud (e.g., a first likelihood threshold is met), requiring further analysis.

It should be noted that such fraud detection is not limited to interactions taking place over the phone (or over the internet). For example, fraud may be detectable in in-person situations as well, e.g., in a supermarket or a shop, where the fraud detection system may have previously stored information and/or use sensors, microphones, video cameras, etc., to analyze interactions, e.g., in real time.

In point of sale (POS), for example, in some embodiments, the processor may be configured to take measures of sale interactions, such as information about the buyer and context information. Information about the buyer may be or include, for example, data recorded from sensors such as height, sex, color, clothes, glasses, health, etc.; voice biometric and movement stress indicators; whether the buyer seems to be in a hurry; the order in which the buyer put the items on the belt, etc.

Context information may be or may include, for example, whether the buyer is with someone or alone, and/or with whom; the length of the line of customers; whether the buyer chose the shortest line, etc.

Next, at step 230, in some embodiments, the processor may be configured to select one or more questions associated with the suspected fraud category or type to be presented or transmitted to the user. For example, if the fraud suspected is identity fraud (e.g., not card owner) one or more questions may be selected (or generated) and asked or otherwise presented (e.g., by an interactive voice response (IVR) system, on a display screen, etc.) relating to the spelling of the purchaser's name (and/or any other identity-related question). If, for example, the fraud suspected is shared card fraud, one or more questions may be selected and asked, transmitted or otherwise presented (e.g., by an interactive voice response (IVR) system) relating to other members with whom the card is shared (rather than questions about the identity of the purchaser). If, for example, the fraud suspected is policy fraud (e.g., intent to use the item and return it), then one or more questions may be selected and asked or otherwise presented (e.g., by an interactive voice response (IVR) system) relating to expected use. In each of these examples, and in other embodiments, questions may be selected based on the type of fraud suspected, and asked or otherwise presented to the purchaser, e.g., to potentially prompt or elicit a stressful response from the purchaser.

At step 235, in some embodiments, the processor may be configured to receive a first voice input or response from the user, e.g. audio input, in response to the one or more presented questions. In some embodiments, the first voice input may be responsive or unresponsive to the questions asked (e.g., the suspected fraudster may provide an answer which may or may not actually answer the question asked). If a voice response is received, then, in some embodiments, a voice analysis of the first voice input may be performed (e.g., if an initial voice input had not previously been received prior to presenting the questions). If no voice response is provided or received, then in some embodiments, further measures may be taken. For example, a non-verbal response (e.g., the pressing of a button on the phone, the disconnecting from the call, a person retreating from a POS, etc.) may trigger alternative fraud analysis (e.g., non-voice-related analysis) and/or alternative responses (e.g., blocking a caller ID, contacting a customer service department or a fraud department, initiating a fraud reporting to police, etc.).

At step 240, in some embodiments, provided a first voice input was received, the processor may be configured to implement a second fraud analysis, i.e., a fraud analysis on the first voice input, e.g., based on the first transaction request, the one or more request parameters and/or based on the first fraud analysis (e.g., to the extent the first fraud analysis may be informative with respect to the second fraud analysis).

At step 245, in some embodiments, the processor may be configured to determine a revised likelihood or probability of fraud based on the second fraud analysis. For example, in some embodiments, a second likelihood threshold may be set which enables further calibration of the fraud detection system such that only suspected fraud that reaches a certain second threshold level is treated with yet a higher level of caution and may prompt further action, whereas a determination that the suspected fraud does not reach the second likelihood threshold may be an indication of no fraud (or lowered risk of fraud as compared to prior determinations).

In some embodiments, if the revised likelihood of fraud is below the first likelihood threshold, the processor may be configured to return an indication of, e.g., no fraud or lower likelihood of fraud. In some embodiments, if the revised likelihood of fraud is above a second likelihood threshold, the processor may be configured to return an indication of fraud (or an indication of a higher likelihood of fraud than previously determined). In some embodiments, the processor may continue an iterative process, e.g., with one or more further rounds of questions, additional voice inputs (e.g., second, third, etc.), and subsequent fraud analyses, and with further predefined or dynamic thresholds, e.g., until a final determination can be made. In such an iterative process, the example process of FIG. 2 may move from operation 245 to operation 220.

In some embodiments, additional data may be required, based on a given voice response, to complete a given fraud analysis. Accordingly, in some embodiments, the processor may be configured to retrieve or receive additional data based on responses, e.g., from a third-party server such as a social media account, online records, provided by the purchaser (e.g., showing a driver's license or providing a social security number), etc.

Embodiments of the invention provide a practical, real-world improvement to prior art fraud detection systems by adding to any fraud detection algorithm substantially more relevant information which would otherwise not be provided, thus significantly improving fraud detection rates and providing better validation.

For example, insurance claims are fraught with fraud. A claimant may be lying about the event happening (e.g., “someone broke into my house”), may be lying about the value of the merchandise stolen, may be lying about the specific item claimed to be stolen, etc. As another example, during job interviews, applicants may weave untruths into their responses to questions. An interviewer may have a notion that the applicant is lying about something but have no indication as to whether it is their age (lower risk issue) or their criminal history (e.g., higher risk issue). Accordingly, embodiments of the invention may enable the processor to “listen” to the conversation, e.g., in real time or in a recording, and provide guided feedback regarding the potential fraud. If stress is detected regarding a specific question, further responses may be elicited, to hone in on the potential fraud.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of context-based fraud detection, comprising:
receiving, by a processor, a transaction request from a user, the transaction request comprising one or more request parameters;
implementing, by the processor, a first fraud analysis using machine learning on the transaction request based on at least one of the transaction request or the one or more request parameters;
determining, by the processor, an initial likelihood of fraud based on the first fraud analysis; and
if the initial likelihood of fraud meets a first likelihood threshold:
identifying, by the processor, a suspected fraud type based on at least one of the transaction request, at least one of the one or more request parameters, or the first fraud analysis, the suspected fraud type including one or more of: an identity fraud, a shared card fraud, and a policy fraud;
selecting, by the processor, one or more questions associated with the suspected fraud type to be presented to the user, the questions associated with the suspected fraud selected to prompt stressful response from the user;
receiving, by the processor, a voice input from the user in response to the one or more presented questions;
implementing, by the processor, a second fraud analysis on the voice input based on at least one of the transaction request, the one or more request parameters, or the first fraud analysis, wherein the completing of a second fraud analysis comprises retrieving, by the processor, additional data from a third-party server based on the voice input;
determining, by the processor, a revised likelihood of fraud based on the second fraud analysis; and
continuing, by the processor, an iterative process with one or more further rounds of one or more questions and subsequent fraud analyses of further voice inputs, wherein one or more further predefined or dynamic thresholds are used in each of the one or more further rounds, until a final determination can be made;
wherein the second fraud analysis is based on at least one of: voice biometric stress indicators, and movement stress indicators.

2. The method as in claim 1, wherein:
if the revised likelihood of fraud is below the first likelihood threshold, returning, by the processor, an indication of no fraud.

3. The method as in claim 1, wherein:
if the revised likelihood of fraud is above a second likelihood threshold, returning, by the processor, an indication of fraud.

4. (canceled)

5. (canceled)

6. (canceled)

7. (canceled)

8. (canceled)

9. The method as in claim 1, wherein determining at least one of the initial likelihood of fraud or the revised likelihood of fraud occurs in real time.

10. A system for context-based fraud detection, the system comprising:
a memory, and
a processor configured to:
receive a transaction request from a user, the transaction request comprising one or more request parameters;
implement a first fraud analysis using machine learning on the transaction request based on at least one of the transaction request or the one or more request parameters;
determine an initial likelihood of fraud based on the first fraud analysis;
if the initial likelihood of fraud meets a first likelihood threshold:
identify a suspected fraud type based on at least one of the transaction request, at least one of the one or more request parameters, or the first fraud analysis, the suspected fraud type including one or more of: an identity fraud, a shared card fraud, and a policy fraud;
select one or more questions associated with the suspected fraud type to be presented to the user, the questions associated with the suspected fraud selected to prompt stressful response from the user;
receive a voice input from the user in response to the one or more presented questions;
implement a second fraud analysis on the voice input based on at least one of the transaction request, the one or more request parameters, or the first fraud analysis, wherein the completing of a second fraud analysis comprises retrieving, by the processor, additional data from a third-party server based on the voice input;
determine a revised likelihood of fraud based on the second fraud analysis; and
continue an iterative process with one or more further rounds of one or more questions and subsequent fraud analyses of further voice inputs, wherein one or more further predefined or dynamic thresholds are used in each of the one or more further rounds, until a final determination can be made;
wherein the second fraud analysis is based on at least one of: voice biometric stress indicators, and movement stress indicators.

11. The system as in claim 10, wherein the processor is configured to:
if the revised likelihood of fraud is below the first likelihood threshold, return an indication of no fraud.

12. The system as in claim 10, wherein the processor is configured to:
if the revised likelihood of fraud is above a second likelihood threshold, return an indication of fraud.

13. (canceled)

14. (canceled)

15. (canceled)

16. (canceled)

17. (canceled)

18. The system as in claim 10, wherein determining at least one of the initial likelihood of fraud or the revised likelihood of fraud occurs in real time.

19. A method of fraud detection comprising:
receiving, by a processor, a transaction request comprising one or more parameters;
analyzing, by the processor, the transaction request using machine learning to determine a fraud probability;
if the fraud probability meets a first threshold, then:
determining a suspected fraud category based on at least one of the transaction request, at least one of the one or more request parameters, or the analyzing of the transaction request, the suspected fraud category including one or more of: an identity fraud, a shared card fraud, and a policy fraud;
transmitting one or more questions associated with the suspected fraud category to a user, the questions associated with the suspected fraud selected to prompt stressful response from the user;
receiving voice response from the user;
determining, by the processor, a revised fraud probability based on the voice response; and
continuing, by the processor, an iterative process with one or more further rounds of one or more questions and subsequent fraud probability determinations of further voice inputs, wherein one or more further predefined or dynamic thresholds are used in each of the one or more further rounds, until a final determination can be made;
wherein the determining of a revised fraud probability is based on at least one of: voice biometric stress indicators, and movement stress indicators.

20. The method of claim 1, wherein determining a revised likelihood of fraud uses a second likelihood threshold.

21. The method of claim 1, wherein the first fraud analysis is based on at least one of voice biometric and movement stress indicators.
